(19) United States
(12) Patent Application Publication
(10) Pub. No.: US 2025/0327908 A1
(43) Pub. Date: Oct. 23, 2025

(54) TIME-OF-FLIGHT MEASUREMENT SYSTEMS AND LASER RANGING DEVICES

(71) Applicant: SUTENG INNOVATION TECHNOLOGY CO., LTD., Shenzhen (CN)

(72) Inventors: Wei TAN, Shenzhen (CN); Junling ZANG, Shenzhen (CN)

(73) Assignee: SUTENG INNOVATION TECHNOLOGY CO., LTD., Shenzhen (CN)

(21) Appl. No.: 19/255,943

(22) Filed: Jun. 30, 2025

Related U.S. Application Data
(63) Continuation of application No. PCT/CN2022/144123, filed on Dec. 30, 2022.

(51) Int. Cl. G01S 7/4865; G01S 7/4863

(52) U.S. Cl. CPC G01S 7/4865; G01S 7/4863

(57) ABSTRACT

A time-of-flight measurement system and a laser ranging device is provided. The time-of-flight measurement system includes a detector array and a statistics module. The detector array includes a first detection module group including t detection modules arranged in sequence. The statistics module includes a first selection module group and a first statistics module group. The first selection module group includes a first group of first selection components used to select, in sequence, the flight time data set corresponding to each of the t detection modules, so as to output, in a time-sharing manner, the flight time data set corresponding to each of the t detection modules. The first statistics module group includes a first group of first statistics components used to count the flight time data set corresponding to the detection module selected by the first group of first selection components.

### CROSS-REFERENCE TO RELATED APPLICATION

The present application claims the benefit of priority to International Application No. PCT/CN2022/144123, filed on Dec. 30, 2022, which is hereby incorporated by reference in its entirety.

### TECHNICAL FIELD

The present disclosure belongs to the technical field of ranging, and particularly relates to a time-of-flight measurement system and a laser ranging device.

### BACKGROUND

Time-of-flight (TOF) measurement technology has important applications in fields such as autonomous driving, face recognition, and 3D gesture recognition. In a time-of-flight measurement system, a light emitting unit emits a pulse signal, and a detector, such as a single photon avalanche diode (SPAD), receives the echo signal, performs photoelectric conversion and avalanche effect to generate a pulse electrical signal, and the detector transmits the pulse electrical signal to a sampling circuit, such as a time-to-digital converter (TDC), which records the time of the pulse electrical signal. Then, according to the time of the pulse electrical signal recorded by the sampling circuit, histogram data is statistically obtained, and the histogram data is written into a storage unit. The histogram data written into the storage unit needs to be output to a subsequent data processing system for processing, and the data processing system determines the time-of-flight according to the histogram data, so as to calculate the distance between the laser and the object according to the time-of-flight.

At present, one implementation form of the detector is an array detector, which is composed of a plurality of detection units arranged in an array. When a plurality of detection units included in the array detector perform time-of-flight measurement, a plurality of flight time data sets corresponding to the detection units will be generated. When counting the flight time data sets corresponding to the plurality of detection units to generate the histogram data corresponding to the plurality of detection units, a large number of statistics channels are required, resulting in increased hardware resource overhead required for statistics.

How to save the storage space and hardware resource overhead required by a time-of-flight measurement system using an array detector has become a technical problem that those skilled in the art need to solve.

### SUMMARY

The objective of the present disclosure is to provide a time-of-flight measurement system and a laser ranging device, aiming to save the hardware resource overhead and storage capacity required by a time-of-flight measurement system using an array detector.

In a first aspect, an embodiment of the present disclosure provides a time-of-flight measurement system, including:
a detector array, including a first detection module group, where the first detection module group includes t detection modules arranged in sequence, and each detection module includes m*n detection units, t, m, and n are all positive integers, and t≥1, m≥1, n≥1; and
a statistics module, including a first selection module group and a first statistics module, where the first selection module group includes a first group of first selection components, and the first group of first selection components correspond one-to-one with the first detection module group, the first statistics module includes a first group of first statistics components, and the first group of first statistics components correspond one-to-one with the first group of first selection components.

The first group of first selection components are used to select, in sequence, the flight time data set corresponding to each of the t detection modules included in the first detection module according to a first preset order, so as to output, in a time-sharing manner, the flight time data set corresponding to each of the t detection modules included in the first detection module group to the first group of first statistics components. Each flight time data set is used to indicate a photon event of one detection unit in one flight time statistics period. The first group of first statistics components are used to count the flight time data set corresponding to the detection module selected by the first group of first selection components, so as to generate the histogram data corresponding to the detection module selected by the first group of first selection components.

In a second aspect, the present disclosure further provides a laser ranging device, including the above time-of-flight measurement system.

Compared with the related art, the beneficial effects of the embodiments of the present disclosure are as follows: the time-of-flight measurement system provided by the present disclosure, through the first group of first selection components selecting, in sequence, the flight time data set corresponding to each of the t detection modules included in the first detection module group according to a first preset order, so as to output, in a time-sharing manner, the flight time data set corresponding to each of the t detection modules included in the first detection module group to the first group of first statistics components, only needs one first group of first statistics components to count the flight time data set corresponding to each of the t detection modules, and generate the histogram data corresponding to each of the t detection modules. There is no need to set a one-to-one corresponding first group of first statistics components for each detection module, thereby reducing the number of statistics channels and saving the hardware resource overhead required for the time-of-flight measurement system to count the histogram data of multiple detection modules.

### BRIEF DESCRIPTION OF DRAWINGS

In order to more clearly illustrate the technical solutions in the embodiments of the present disclosure, the drawings used in the description of the embodiments or exemplary technical descriptions are briefly introduced below. It is obvious that the drawings described below are only some embodiments of the present disclosure, and those of ordinary skill in the art can also obtain other drawings based on these drawings without creative work.

FIG. 1 is a schematic system structure diagram of a time-of-flight measurement system provided in an embodiment of the present disclosure;

FIG. 2 is a schematic structural diagram of a first detection module group, a first selection module group, a first statistics module, and a first storage module of a time-of-flight measurement system provided in an embodiment of the present disclosure;

FIG. 3 is a schematic structural diagram of a first detection module group, a first selection module group, and a first statistics module of a time-of-flight measurement system provided in an embodiment of the present disclosure;

FIG. 4 is another schematic structural diagram of a first detection module group, a first selection module group, and a first statistics module of a time-of-flight measurement system provided in an embodiment of the present disclosure;

FIG. 5 is a specific schematic structural diagram of a first detection module group, a first selection module group, and a first statistics module of a time-of-flight measurement system provided in FIG. 4;

FIG. 6 is a specific schematic structural diagram of a first detection module group, a first selection module group, a first statistics module, and a first storage module of a time-of-flight measurement system provided in an embodiment of the present disclosure;

FIG. 7 is a schematic structural diagram of a first detection module group, a first selection module group, a first statistics module, and a first storage module of a time-of-flight measurement system provided in another embodiment of the present disclosure;

FIG. 8 is a schematic structural diagram of a first detection module group, a first selection module group, a first statistics module, and a first storage module, as well as a second detection module group, a second selection module group, a second statistics module, and a second storage module of a time-of-flight measurement system provided in another embodiment of the present disclosure;

FIG. 9 is a schematic structural diagram of a first detection module group, a first selection module group, and a first statistics module, as well as a second detection module group, a second selection module group, and a second statistics module of a time-of-flight measurement system provided in another embodiment of the present disclosure;

FIG. 10 is another schematic structural diagram of a first detection module group, a first selection module group, and a first statistics module, as well as a second detection module group, a second selection module group, and a second statistics module of a time-of-flight measurement system provided in another embodiment of the present disclosure;

FIG. 11 is a specific schematic structural diagram of a second detection module group, a second selection module group, and a second statistics module of a time-of-flight measurement system provided in FIG. 10;

FIG. 12 is a specific schematic structural diagram of a second detection module group, a second selection module group, a second statistics module, and a second storage module of a time-of-flight measurement system provided in another embodiment of the present disclosure;

FIG. 13 is a schematic structural diagram of a first detection module group, a first selection module group, a first statistics module, and a first storage module, as well as a second detection module group, a second selection module group, a second statistics module, and a second storage module of a time-of-flight measurement system provided in another embodiment of the present disclosure; and

FIG. 14 is a schematic structural diagram of a time-of-flight measurement system provided in another embodiment of the present disclosure.

### DETAILED DESCRIPTION

In order to make the objectives, technical solutions, and advantages of the present disclosure clearer, the following provides a further detailed description of the present disclosure in conjunction with the accompanying drawings and embodiments. It should be understood that the specific embodiments described herein are only for the purpose of illustrating the present disclosure and are not intended to limit the present disclosure.

It should be noted that when a component is described as being “fixed to” or “disposed on” another component, it may be directly on the other component or indirectly on the other component. When a component is described as being “connected to” another component, it may be directly or indirectly connected to the other component. The terms “upper,” “lower,” “left,” “right,” and the like, indicating orientation or positional relationships, are based on the orientation or positional relationships shown in the drawings, and are only for the convenience of description, and are not intended to indicate or imply that the device or element referred to must have a particular orientation, be constructed and operated in a particular orientation, and therefore should not be construed as limiting the present disclosure. For those of ordinary skill in the art, the specific meanings of the above terms can be understood according to the specific circumstances. The terms “first,” “second,” “third,” etc. are only used for the purpose of description and should not be construed as indicating or implying relative importance or implicitly indicating the number of technical features. The meaning of “a plurality of” is two or more, unless otherwise specifically defined.

In order to illustrate the technical solutions provided by the present disclosure, the following provides a detailed description in conjunction with specific drawings and embodiments.

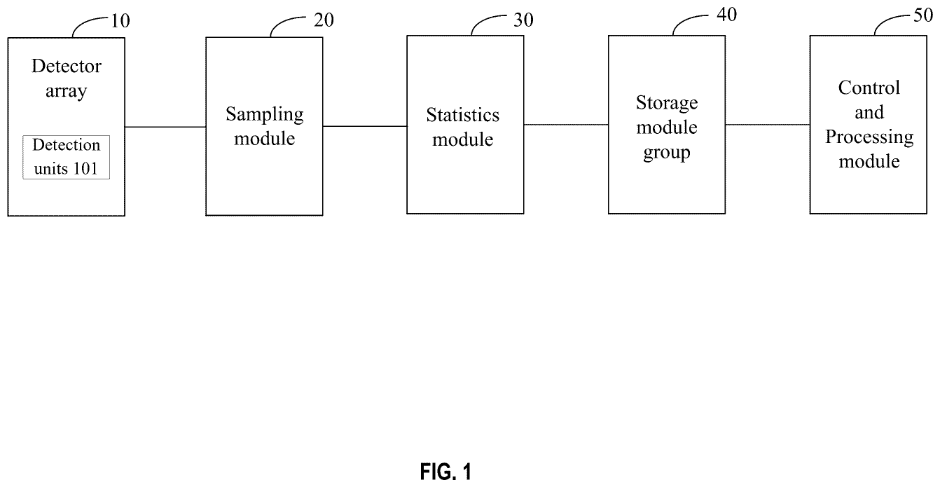

FIG. 1 shows a schematic structural diagram of a time-of-flight measurement system provided by the present disclosure. For the sake of clarity, only the parts relevant to embodiments of the present disclosure are shown, and the details are as follows.

The above time-of-flight measurement system includes a detector array 10, a sampling module 20, a statistics module 30, a storage module group 40, and a control and processing module 50. The detector array 10 includes a plurality of detection units 101 arranged in an array, and the plurality of detection units 101 are used to receive optical signals and convert the optical signals into electrical signals. The optical signals received by the detection units 101 include echo light signals that are emitted by a light emitting unit as pulse light signals, reflected by obstacles in the detection area, and returned. The sampling module 20 is connected to the detection units 101 in the detector array 10 and is used to generate corresponding flight time data according to the electrical signals converted by the detection units 101. The flight time data includes a flight time period and the number of photons corresponding to the flight time period, and is used to indicate the generation time of the electrical signal of the corresponding detection unit 101, so as to indicate the arrival time of the optical signal received by the corresponding detection unit 101. The statistics module 30 is connected to the sampling module 20 and the storage module group 40, and is used to count histogram data corresponding to each detection unit 101 according to the flight time data output by the sampling module 20. The storage module group 40 is connected to the statistics module 30 and the control and processing module 50, and is used to write the histogram data corresponding to each detection unit 101 counted by the statistics module 30, and output the histogram data corresponding to each detection unit 101 to the control and processing module 50. The control and processing module 50 is used to control the light emitting unit to emit optical signals, control the detection units 101 to receive optical signals, and is also used to receive the histogram data corresponding to each detection unit 101, process the histogram data corresponding to each detection unit 101, and determine the time-of-flight detected by each detection unit 101.

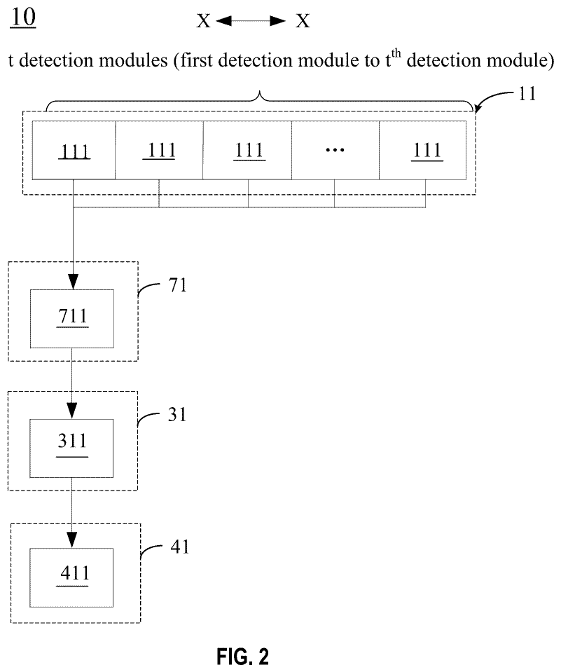

As shown in FIG. 2, the detector array 10 includes a first detection module group 11. The first detection module group 11 includes t detection modules 111 arranged in sequence, and each detection module 111 includes m*n detection units 101. t, m, and n are all positive integers, and t≥1, m≥1, n≥1. The statistics module 30 includes a first selection module group 71 and a first statistics module 31. The first selection module group 71 includes a first group of first selection components 711, and the first group of first selection components 711 corresponds one-to-one with the first detection module group 11. The first statistics module 31 includes a first group of first statistics components 311, and the first group of first statistics components 311 correspond one-to-one with the first group of first selection components 711. The first group of first selection components 711 is used to select, in sequence, a flight time data set corresponding to each of the t detection modules 111 included in the first detection module group 11 according to a first preset order, so as to output, in a time-sharing manner, the flight time data set corresponding to each of the t detection modules 111 included in the first detection module group 11 to the first group of first statistics components 311. The flight time data set corresponding to a detection module 111 includes the flight time data sets corresponding to the m*n detection units 101 in the detection module 111. Each flight time data set is used to indicate a photon event of one detection unit 101 in one flight time statistics period. The first group of first statistics components 311 are used to count the flight time data set corresponding to the detection module selected by the first group of first selection components 711, so as to generate histogram data corresponding to the detection module 111 selected by the first group of first selection components. The histogram data corresponding to a detection module 111 includes the histogram data of the m*n detection units 101 in the detection module 111.

In some specific embodiments, the detection unit 101 adopts a silicon photomultiplier (SiPM). The silicon photomultiplier is a new type of photoelectric detection device, composed of an array of avalanche diodes operating in Geiger mode, and has the characteristics of high gain, high sensitivity, low bias voltage, insensitivity to magnetic fields, and compact structure. In other embodiments, the detection unit 101 may also adopt a single photon avalanche diode (SPAD). The present disclosure does not limit the specific type of the detection unit 101.

As shown in FIG. 2, the t detection modules 111 in the first detection module group 11 include a first to a t^{th} detection module arranged in sequence along a first direction X-X. The first preset order may be from the first detection module to the t^{th} detection module, that is, the first preset order may be from left to right. The first preset order may also be from the t^{th} detection module to the first detection module, that is, the first preset order may also be from right to left.

In some specific embodiments, the first group of first selection components 711 selects, in sequence, the flight time data set corresponding to each of the t detection modules 111 included in the first detection module group 11 according to the first preset order, so as to output, in a time-sharing manner, the flight time data set corresponding to each of the t detection modules 111 included in the first detection module group 11 to the first group of first statistics components 311. This may be implemented by selecting, in sequence, the flight time data set corresponding to each of the t detection modules 111 included in the first detection module group 11 during time periods Ti to T₁ₜ, so as to output, in a time-sharing manner, the flight time data set corresponding to each of the t detection modules 111 included in the first detection module group 11 to the first group of first statistics components 311 during time periods T₁₁ to T₁ₜ. Specifically, the first group of first selection components 711 selects the flight time data set corresponding to the first detection module 111 during the Tn period and output it to the first group of first statistics components 311. The first group of first statistics components 311 count the flight time data set corresponding to the first detection module 111 to generate the histogram data corresponding to the first detection module 111. The first group of first selection components 711 selects the flight time data set corresponding to the second detection module 111 during the T₁₁ period and output it to the first group of first statistics components 311. The first group of first statistics components 311 count the flight time data set corresponding to the second detection module 111 to generate the histogram data corresponding to the second detection module 111. The first group of first selection components 711 selects the flight time data set corresponding to the t^{th} detection module 111 during the T₁ₜ period and output it to the first group of first statistics components 311. The first group of first statistics components 311 count the flight time data set corresponding to the t^{th} detection module 111 to generate the histogram data corresponding to the t^{th} detection module 111. The time periods T₁₁ to T₁ₜ are arranged in sequence along the time axis.

The time-of-flight measurement system provided by the present disclosure, through the first group of first selection components 711 selecting, in sequence, the flight time data set corresponding to each of the t detection modules 111 included in the first detection module group 11 according to the first preset order, so as to output, in a time-sharing manner, the flight time data set corresponding to each of the t detection modules 111 included in the first detection module group 11 to the first group of first statistics components 311, only needs one first group of first statistics components 311 to count the flight time data set corresponding to each of the t detection modules 111 included in the first detection module group 11, and generate the histogram data corresponding to each of the t detection modules 111 included in the first detection module group 11. There is no need to set a one-to-one corresponding first group of first statistics components 311 for each detection module 111, thereby reducing the number of statistics channels and saving the hardware resource required for the time-of-flight measurement system to count the histogram data of multiple detection modules 111.

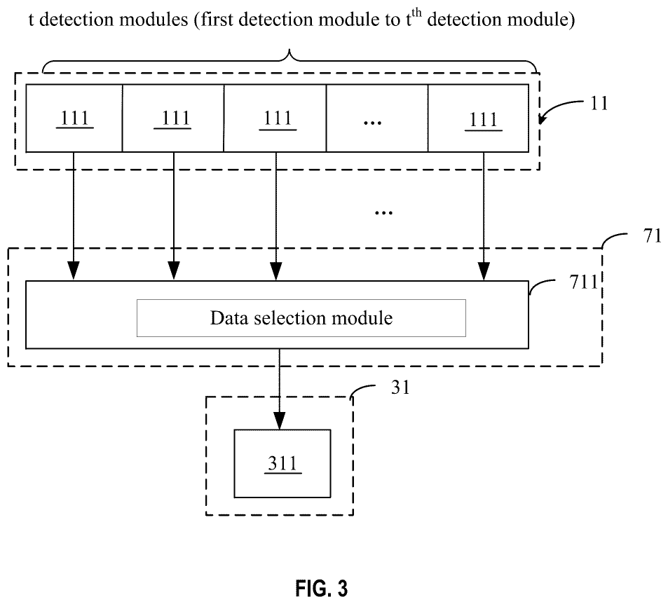

As shown in FIG. 3, in an embodiment, the first group of first selection components 711 may adopt a t-to-1 data selection module. The t-to-1 data selection module includes t groups of input terminals and one group of output terminals. The t groups of input terminals of the t-to-1 data selection module are respectively used to receive the flight time data set corresponding to each of the t detection modules 111 included in the first detection module group 11. Each group of input terminals may include a plurality of data input terminals for receiving the flight time data set corresponding to one detection module 111. The t-to-1 data selection module is used to select, in sequence, the flight time data set corresponding to each of the t detection modules 111 included in the first detection module group 11 according to the first preset order, so as to output, in a time-sharing manner, the flight time data set corresponding to each of the t detection modules 111 included in the first detection module group 11 through one group of output terminals. The group of output terminals of the t-to-1 data selection module may include a plurality of data output terminals for outputting the flight time data set corresponding to the detection module 111 currently selected by the t-to-1 data selection module.

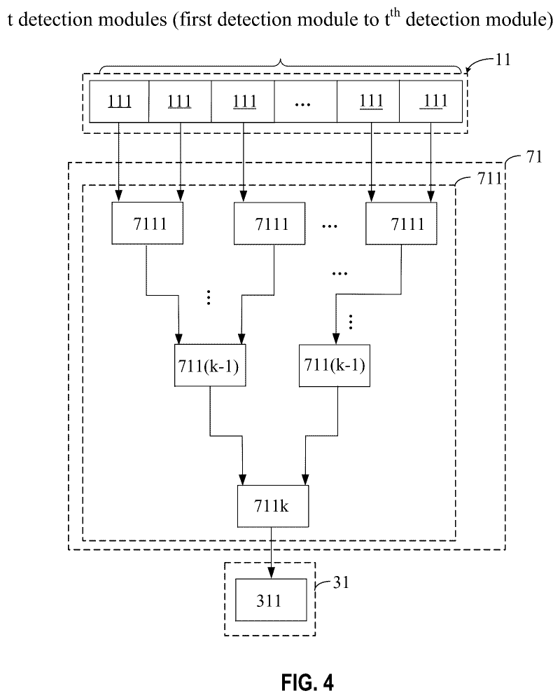

As shown in FIG. 4, in an embodiment, the first group of first selection components 711 includes a first-level data selection module 7111 to a k^{th}-level data selection module 711k. The first-level data selection module 7111 to the k^{th}-level data selection module 711k are all 2-to-1 data selection modules. k is a positive integer greater than 1, and 2k−1≤t<2k.

When t=2*i₀, i₀ is a positive integer greater than or equal to 1, the number t of detection modules 111 included in the first detection module group 11 is an even positive integer greater than or equal to 2. The first group of first selection components 711 includes i₀ first-level data selection modules 7111. For every two adjacent detection modules 111 among the t detection modules 111 included in the first detection module group 11, the flight time data set corresponding to each is input into one first-level data selection module 7111, generating i₁ first-level selection results, where i₁=i₀. When t=2*i₀+1, that is, the number t of detection modules 111 included in the first detection module group 11 is an odd positive integer greater than or equal to 3, for every two adjacent detection modules 111 among the first 2*i₀ detection modules 111 of the first detection module group 11, the flight time data set corresponding to each is input into one first-level data selection module 7111, generating i₀ first-level sub-selection results. The i0 first-level sub-selection results and the flight time data set corresponding to the (2*i₀+1)^{th} detection module 111 (that is, the t^{th} detection module 111) of the first detection module group 11 together form 11 first-level selection results, i₁=i₀+1.

When the number of j^{th}-level selection results iⱼ₌₂*iⱼ₀, iⱼ₀ is a positive integer greater than or equal to 1, the first group of first selection components 711 includes iⱼ₀ (j+1)^{th}-level data selection modules 711 (j+1). For every two adjacent j^{th}-level selection results among the 2*iⱼ₀ j^{th}-level selection results, each is input into one (j+1)^{th}-level data selection module 711 (j+1), generating iⱼ₊₁ (j+1)^{th}-level selection results, where iⱼ₊₁=iⱼ₀. When the number of j^{th}-level selection results iⱼ₌₂*iⱼ₀+1, for the first iⱼ₌₂*iⱼ₀ j^{th}-level selection results among the 2*iⱼ₀+1 j^{th}-level selection results, every two adjacent j^{th}-level selection results are input into one (j+1)^{th}-level data selection module 711 (j+1), generating iⱼ₀ j^{th}-level sub-selection results. The iⱼ₀ j^{th}-level sub-selection results and the (2*iⱼ₀+1)^{th} j^{th}-level selection result together form iⱼ₊₁ (j+1)^{th}-level selection results, where iⱼ₊₁=iⱼ₀+1. j is a positive integer, 1≤j≤k−1, and iⱼ₀ is a positive integer greater than or equal to 2. When j=k−1, the number of (k−1)^{th}-level selection results iₖ₋₁=2. The first group of first selection components 711 includes i₍ₖ₋₁₎₀ k^{th}-level data selection modules 711k, i₍ₖ₋₁₎₀=1, that is, the first group of first selection components 711 includes one k^{th}-level data selection module 711k. One k^{th}-level data selection module 711k is used to receive two (k−1)^{th}-level selection results and output one k^{th}-level selection result.

When the first-level data selection module 7111 to the k^{th}-level data selection module 711k in the first group of first selection components 711 all select the flight time data set corresponding to a certain detection module 111 in the first detection module group 11, the k^{th}-level data selection module 711k outputs the flight time data set corresponding to the detection module 111 to the first group of first statistics components 311. The first group of first statistics components 311 count the flight time data set corresponding to the detection module 111 to generate the histogram data corresponding to the detection module 111. When the first-level data selection module 7111 to the k^{th}-level data selection module 711k in the first group of first selection components 711 all select the flight time data set corresponding to the first detection module 111 during the Tu period, the k^{th}-level data selection module 711k outputs the flight time data set corresponding to the first detection module 111 to the first group of first statistics components 311. The first group of first statistics components 311 count the flight time data set corresponding to the first detection module 111 to generate the histogram data corresponding to the first detection module 111. When the first-level data selection module 7111 to the k^{th}-level data selection module 711k in the first group of first selection components 711 all select the flight time data set corresponding to the second detection module 111 during the T₁₂ period, the k^{th}-level data selection module 711k outputs the flight time data set corresponding to the second detection module 111 to the first group of first statistics components 311. The first group of first statistics components 311 count the flight time data set corresponding to the second detection module 111 to generate the histogram data corresponding to the second detection module 111. When the first-level data selection module 7111 to the k^{th}-level data selection module 711k in the first group of first selection components 711 select the flight time data set corresponding to the t^{th} detection module 111 during the T₁ₜ period, the k^{th}-level data selection module 711k outputs the flight time data set corresponding to the t^{th} detection module 111 to the first group of first statistics components 311. The first group of first statistics components 311 count the flight time data set corresponding to the t^{th} detection module 111 to generate the histogram data corresponding to the t^{th} detection module 111. The time periods T₁₁ to T₁ₜ are arranged in sequence along the time axis.

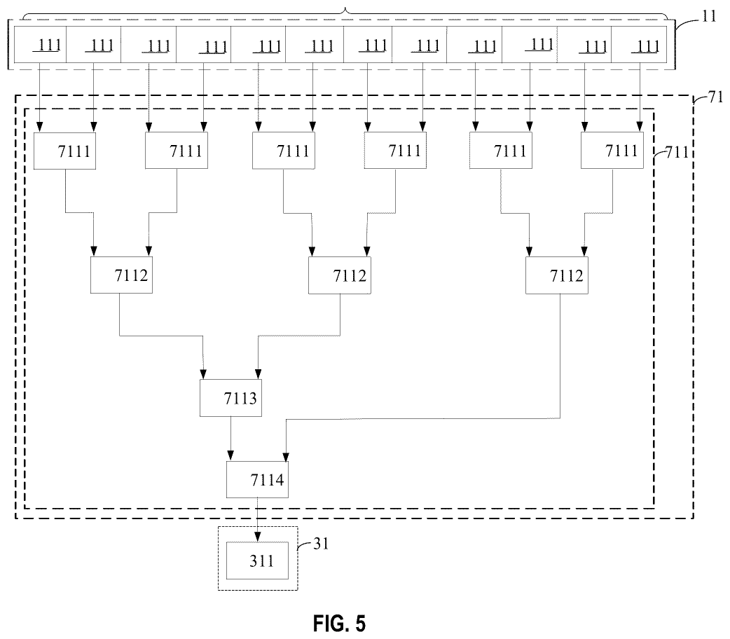

As shown in FIG. 5, in an embodiment, t=12, that is, the first detection module group 11 includes 12 detection modules 111 (that is, the first detection module 111 to the twelfth detection module 111). The first group of first selection components 711 includes a first-level data selection module 7111, a second-level data selection module 7112, a third-level data selection module 7113, and a fourth-level data selection module 7114. The number of first-level data selection modules 7111 included in the first group of first selection components 711 is i₀=6. For every two adjacent detection modules 111 among the 12 detection modules 111 included in the first detection module group 11, the flight time data set corresponding to each is input into one first-level data selection module 7111. The 12 detection modules 111 correspond to six first-level data selection modules 7111, generating six first-level selection results. Furthermore, the number of second-level data selection modules 7112 included in the first group of first selection components 711 is i₁₀=3. For every two adjacent first-level selection results among the six first-level selection results, each is input into one second-level data selection module 7112. The six first-level selection results correspond to three second-level data selection modules 7112, generating three second-level selection results. Furthermore, the number of third-level data selection modules 7113 included in the first group of first selection components 711 is i₂₀=2. Among the three second-level selection results, the first two second-level selection results are input into one third-level data selection module 7113, generating one third-level sub-selection result. The third-level sub-selection result and the third second-level selection result among the three second-level selection results together form two third-level selection results. Furthermore, the number of fourth-level data selection modules 7114 included in the first group of first selection components 711 is i₃₀=2. The two third-level selection results are input into one fourth-level data selection module 7114, generating one fourth-level selection result.

When the first-level data selection module 7111 to the fourth-level data selection module 7114 in the first group of first selection components 711 all select the flight time data set corresponding to a certain detection module 111 among the 12 detection modules 111 in the first detection module group 11, the k^{th}-level data selection module 711k outputs the flight time data set corresponding to the detection module 111 to the first group of first statistics components 311. The first group of first statistics components 311 count the flight time data set corresponding to the detection module 111 to generate the histogram data corresponding to the detection module 111.

The first group of first selection components 711 provided in the above embodiment performs multi-level selection on the flight time data set corresponding to each of the t detection modules 111 included in the first detection module group 11 through k-level data selection modules (that is, the first-level data selection module 7111 to the k^{th}-level data selection module 711k), so as to realize the sequential selection of the flight time data set corresponding to each of the t detection modules 111 included in the first detection module group 11 according to the first preset order, and output, in a time-sharing manner, the flight time data set corresponding to each of the t detection modules 111 included in the first detection module group 11.

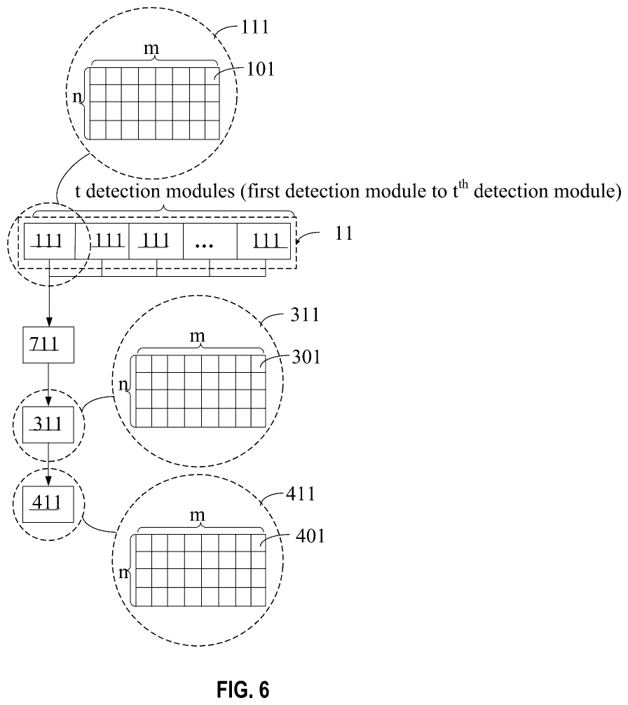

Furthermore, as shown in FIG. 6, the first group of first statistics components 311 includes m*n statistics units 301. The m*n statistics units 301 are respectively used to count the flight time data set corresponding to each of the m*n detection units 101 included in the detection module 111 selected by the first group of first selection components 711, and generate the histogram data corresponding to each of the m*n detection units 101. For example, assuming that any one of the m*n detection units 101 is the p*q^{th} detection unit 101, where p and q are both positive integers, and 1≤p≤m, 1≤q≤n, correspondingly, the p*q^{th} statistics unit 301 in the first group of first statistics components 311 is configured to count the flight time data set corresponding to the p*q^{th} detection unit 101 of the detection module selected by the first group of first selection components 711, and generate the histogram data corresponding to the p*q^{th} detection unit 101 of the detection module selected by the first group of first selection components 711.

The time-of-flight measurement system provided in the embodiments of the present disclosure adopts time-correlated single photon counting (TCSPC) to measure the time-of-flight. The main principle is that the light emitting unit emits pulse light signals multiple times within one detection period. Since the movement speed of the obstacle is much lower than the speed of light, the distance of the obstacle within the same detection period can be regarded as unchanged, that is, the time-of-flight remains unchanged. Therefore, the arrival time of the echo signal has the characteristic of coherence or consistency, while the arrival time of the noise signal is random. After multiple integration periods, the echo signal can stand out from the noise signal.

The basic principle of histogram statistics performed by the statistics unit 301 provided in the embodiments of the present disclosure is as follows.

Each detection unit 101 includes N flight time statistics periods t_{TOF} within a single detection period. Accordingly, each detection unit 101 detects the echo light signal N times within a single detection period, corresponding to N flight time data sets. The statistics unit 301 generates the histogram data corresponding to the detection unit 101 by superimposing the N flight time data sets of each detection unit 101 within a single detection period. The horizontal axis of the histogram represents the time-of-flight, and the vertical axis represents the count value. The time corresponding to the maximum count value in the histogram is the time-of-flight detected by the detection unit 101.

Furthermore, the sampling module 20 includes sampling units corresponding one-to-one with the detection units 101. The sampling unit (not shown) is connected to the corresponding detection unit 101 and is used to generate N flight time data sets according to the electrical signals converted by the corresponding detection unit 101 in N integration periods. The statistics module 30 includes statistics units 301 corresponding one-to-one with the sampling units. The statistics unit 301 is connected to the corresponding sampling unit and is used to receive the N flight time data sets output by the corresponding sampling unit, superimpose the N flight time data sets, generate the histogram data corresponding to the detection unit 101, and write the histogram data corresponding to the detection unit 101 into the corresponding storage component 411.

In an embodiment, the sampling unit adopts a time-to-digital converter (TDC).

As shown in FIG. 2, the storage module group 40 further includes a first storage module 41. The first storage module 41 includes a first group of first storage components 411. The first group of first storage components 411 correspond one-to-one with the first group of first statistics components 311 and are used to write and output the histogram data obtained by the first group of first statistics components 311, so as to write and output, in a time-sharing manner and according to the first preset order, the histogram data corresponding to each of the t detection modules 111 included in the first detection module group 11. As shown in FIG. 6, the first group of first storage components 411 includes m*n storage modules 401. The m*n storage modules 401 correspond one-to-one with the m*n detection units 101 included in each detection module 111 and are respectively used to write and output the histogram data corresponding to each of the m*n detection units 101. For example, assuming that any one of the m*n detection units 101 is the p*q^{th} detection unit 101, where p and q are both positive integers, and 1 μm, 1≤q≤n, correspondingly, the p*q^{th} storage module 401 is configured to write and output the histogram data corresponding to the p*q^{th} detection unit 101 among the t detection modules 111.

The time-of-flight measurement system provided by the present disclosure, through the first group of first storage components 411 corresponding one-to-one with the first group of first statistics components 311, writes and outputs, in a time-sharing manner and according to the first preset order, the histogram data corresponding to each of the t detection modules 111 included in the first detection module group 11. Only one first group of first storage components 411 is needed to write the histogram data corresponding to each of the t detection modules 111 included in the first detection module group 11. There is no need to set a one-to-one corresponding first group of first storage components 411 for each detection module 111, thereby saving the storage capacity required by the time-of-flight measurement system. By outputting, in a time-sharing manner, the histogram data corresponding to each of the t detection modules 111 included in the first detection module group 11 through the first group of first storage components 411, the subsequent hardware structure for data processing of the histogram data corresponding to the t detection modules 111 can be time-division multiplexed, thereby further saving the hardware resource overhead required for data processing by the time-of-flight measurement system.

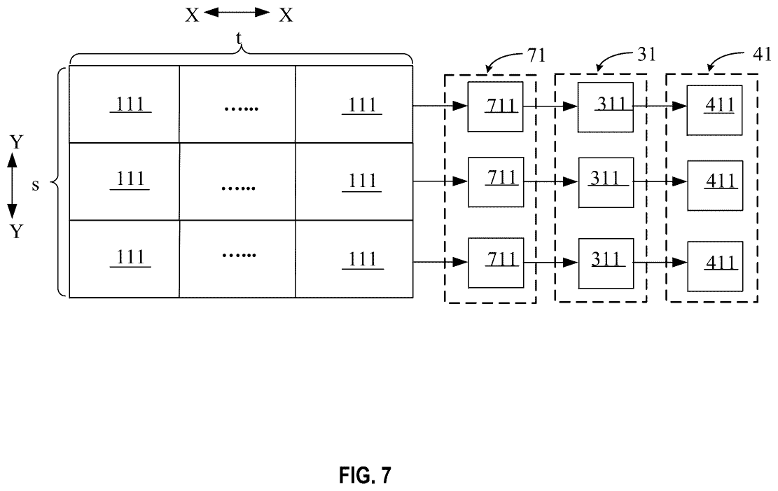

As shown in FIG. 7, the detector array 10 includes s first detection module groups 11, where s is a positive integer and s>1. The s first detection module groups 11 are arranged along a second direction Y-Y. Correspondingly, the first selection module group 71 includes s first groups of first selection components 711, each corresponding to one of the s first detection module groups 11. The first statistics module 31 includes s first groups of first statistics components 311, each corresponding to one of the s first groups of first selection components 711. The first storage module 41 includes s first groups of first storage components 411, each corresponding to one of the s first groups of first statistics components 311.

By way of example and not limitation, the first direction is the horizontal direction X-X (or horizontal direction), and the second direction is the vertical direction Y-Y (or vertical direction). Compared with detection by a single first detection module group 11, the above embodiment, by using a plurality of first detection module groups 11 arranged along the second direction Y-Y for detection, can further expand the detection field of view along the second direction.

For example, the first detection module group 11 in the i^{th} row outputs the flight time data set corresponding to each of the t detection modules 111 included in the first detection module group 11 in the i^{th} row, where i is a positive integer and 1≤i≤s. The i^{th} first group of first selection components 711 selects, in sequence, the flight time data set corresponding to each of the t detection modules 111 included in the first detection module group 11 in the i^{th} row according to the first preset order, so as to output, in a time-sharing manner, the flight time data set corresponding to each of the t detection modules 111 included in the first detection module group 11 in the i^{th} row to the i^{th} first group of first statistics components 311. The i^{th} first group of first statistics components 311 count the flight time data set corresponding to the detection module 111 selected by the i^{th} first group of first selection components 711, so as to generate the histogram data corresponding to the detection module 111 selected by the i^{th} first group of first selection components 711.

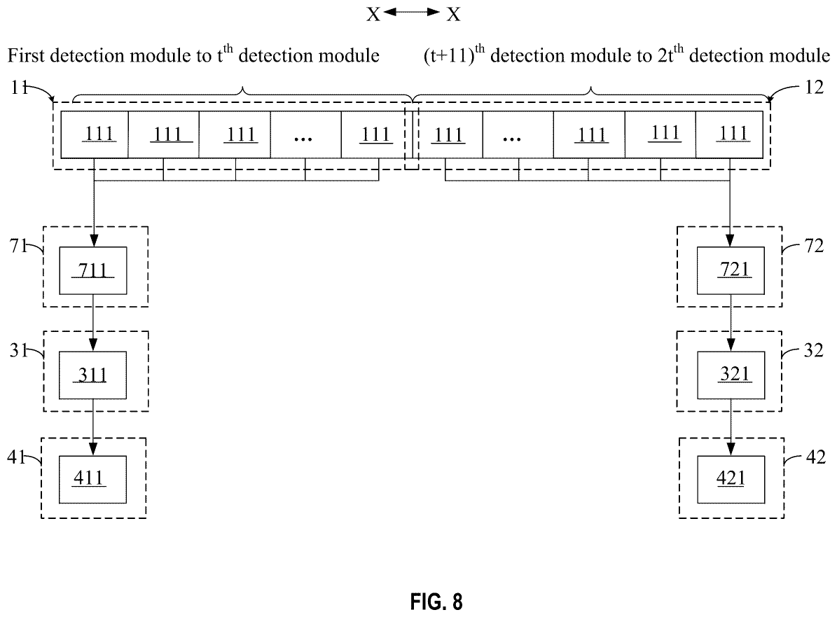

As shown in FIG. 8, in other embodiments, the detector array 10 further includes a second detection module group 12. The second detection module group 12 and the first detection module group 11 are arranged along the first direction X-X, and the second detection module group 12 includes t detection modules 111. The statistics module 30 further includes a second selection module 72 and a second statistics module 32. The second selection module 72 includes a second group of first selection components 721, and the second group of first selection components 721 correspond one-to-one with the second detection module group 12. The second statistics module 32 includes a second group of first statistics components 321, and the second group of first statistics components 321 correspond one-to-one with the second group of first selection components 721. The second group of first selection components 721 are used to select, in sequence, the flight time data set corresponding to each of the t detection modules 111 included in the second detection module group 12 according to a second preset order, so as to output, in a time-sharing manner, the flight time data set corresponding to each of the t detection modules 111 included in the second detection module group 12 to the second group of first statistics components 321. The second group of first statistics components 321 are used to count the flight time data set corresponding to the detection module selected by the second group of first selection components 721, so as to generate the histogram data corresponding to the detection module 111 selected by the second group of first selection components 721.

Furthermore, compared with detection by a single first detection module, the above embodiment, by using the first detection module group 11 and the second detection module group 12 arranged along the first direction for detection, can further expand the detection field of view along the second direction Y-Y.

As shown in FIG. 8, the t detection modules 111 in the first detection module group 11 include a first to a t^{th} detection module arranged in sequence along the first direction X-X. The t detection modules 111 in the second detection module group 12 include a (t+1)^{th} to a (2t)^{th} detection module arranged in sequence along the first direction X-X. The first preset order is from the first detection module to the t^{th} detection module, that is, from left to right. The second preset order may be from the (2t)^{th} detection module to the (t+1)^{th} detection module, that is, from right to left.

In some specific embodiments, the first group of first selection components 711 selects, in sequence, the flight time data set corresponding to each of the t detection modules 111 included in the first detection module group 11 according to the first preset order, so as to output, in a time-sharing manner, the flight time data set corresponding to each of the t detection modules 111 included in the first detection module group 11 to the first group of first statistics components 311. This may be implemented by selecting, in sequence, the flight time data set corresponding to each of the t detection modules 111 included in the first detection module group 11 during time periods Ti to T₁ₜ, so as to output, in a time-sharing manner, the flight time data set corresponding to each of the t detection modules 111 included in the first detection module group 11 to the first group of first statistics components 311 during time periods Ti to T₁ₜ. The second group of first selection components 721 select, in sequence, the flight time data set corresponding to each of the t detection modules 111 included in the second detection module group 12 according to the second preset order, so as to output, in a time-sharing manner, the flight time data set corresponding to each of the t detection modules 111 included in the second detection module group 12 to the second group of first statistics components 321. This may be implemented by selecting, in sequence, the flight time data set corresponding to each of the t detection modules 111 included in the second detection module group 12 during time periods T₁₁ to T₁ₜ, so as to output, in a time-sharing manner, the flight time data set corresponding to each of the t detection modules 111 included in the second detection module group 12 to the second group of first statistics components 321 during time periods T₁₁ to T₁ₜ.

Specifically, the first group of first selection components 711 selects the flight time data set corresponding to the first detection module 111 during the T₁₁ period and outputs it to the first group of first statistics components 311. The first group of first statistics components 311 count the flight time data set corresponding to the first detection module 111 to generate the histogram data corresponding to the first detection module 111. The second group of first selection components 721 select the flight time data set corresponding to the (2t)^{th} detection module 111 during the Tu period and output it to the second group of first statistics components 321. The second group of first statistics components 321 count the flight time data set corresponding to the (2t)^{th} detection module 111 to generate the histogram data corresponding to the (2t)^{th} detection module 111. The first group of first selection components 711 selects the flight time data set corresponding to the second detection module 111 during the T₁₂ period and output it to the first group of first statistics components 311. The first group of first statistics components 311 count the flight time data set corresponding to the second detection module 111 to generate the histogram data corresponding to the second detection module 111. The second group of first selection components 721 select the flight time data set corresponding to the (2t−1)^{th} detection module 111 during the T₁₂ period and output it to the second group of first statistics components 321. The second group of first statistics components 321 count the flight time data set corresponding to the (2t−1)^{th} detection module 111 to generate the histogram data corresponding to the (2t−1)^{th} detection module 111 . . . . The first group of first selection components 711 selects the flight time data set corresponding to the t^{th} detection module 111 during the T₁ₜ period and output it to the first group of first statistics components 311. The first group of first statistics components 311 count the flight time data set corresponding to the t^{th} detection module 111 to generate the histogram data corresponding to the t^{th} detection module 111. The second group of first selection components 721 select the flight time data set corresponding to the (t+1)^{th} detection module 111 during the T₁ₜ period and output it to the second group of first statistics components 321. The second group of first statistics components 321 count the flight time data set corresponding to the (t+1)^{th} detection module 111 to generate the histogram data corresponding to the (t+1)^{th} detection module 111.

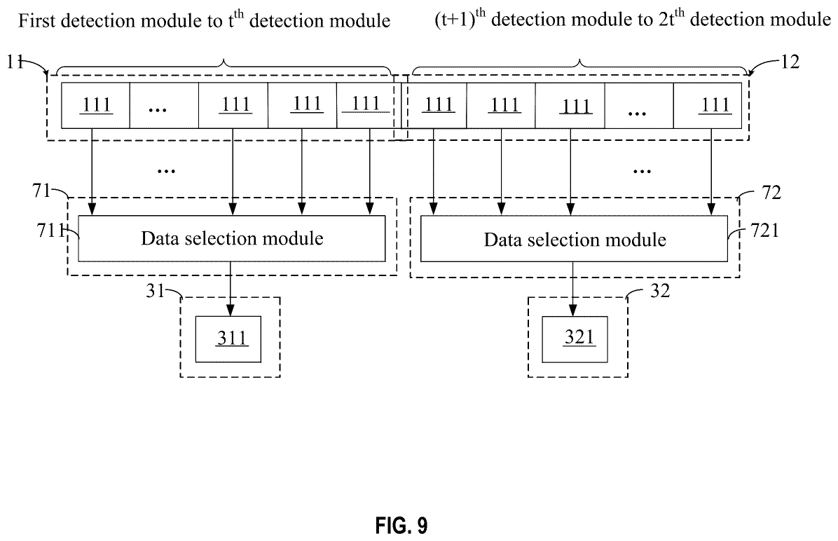

As shown in FIG. 9, in an embodiment, the second group of first selection components 721 may adopt a t-to-1 data selection module. The t-to-1 data selection module includes t groups of input terminals and one group of output terminals. The t groups of input terminals of the t-to-1 data selection module are respectively used to receive the flight time data set corresponding to each of the t detection modules 111 included in the second detection module group 12. Each group of input terminals may include a plurality of data input terminals for receiving the flight time data set corresponding to one detection module 111. The t-to-1 data selection module is used to select, in sequence, the flight time data set corresponding to each of the t detection modules 111 included in the second detection module group 12 according to the second preset order, so as to output, in a time-sharing manner, the flight time data set corresponding to each of the t detection modules 111 included in the second detection module group 12 through one group of output terminals. The group of output terminals of the t-to-1 data selection module may include a plurality of data output terminals for outputting the flight time data set corresponding to the detection module 111 currently selected by the t-to-1 data selection module.

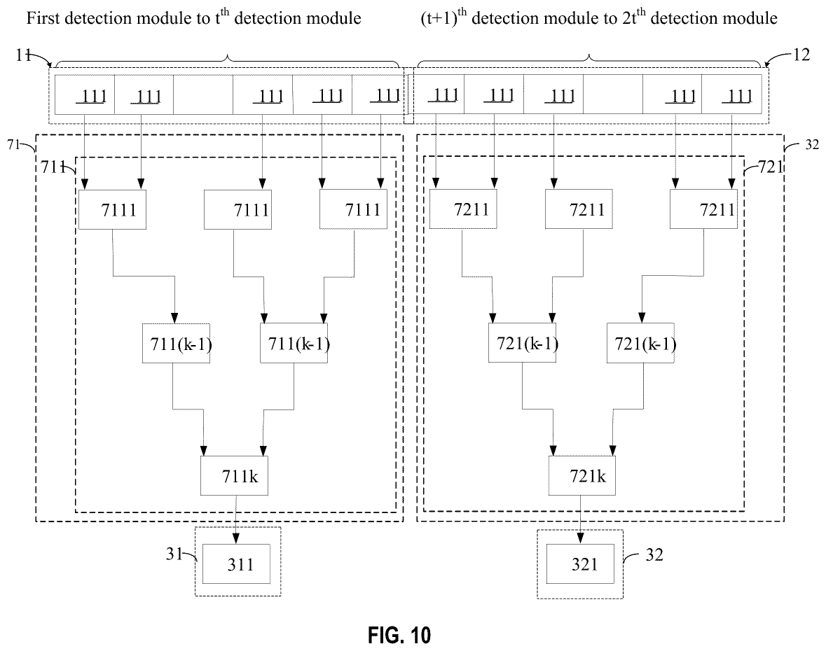

As shown in FIG. 10, in an embodiment, the second group of first selection components 721 includes a first-level data selection module 7211 to a k^{th}-level data selection module 721k. The first-level data selection module 7211 to the k^{th}-level data selection module 721k are all 2-to-1 data selection modules. k is a positive integer greater than 1, and 2k−1≤t<2k.

When t=2*i₀, i₀ is a positive integer greater than or equal to 1, the number t of detection modules 111 included in the second detection module group 12 is an even positive integer greater than or equal to 2. The second group of first selection components 721 includes i₀ first-level data selection modules 7211. For every two adjacent detection modules 111 among the t detection modules 111 included in the first detection module group 11, the flight time data set corresponding to each is input into one first-level data selection module 7211, generating i₁ first-level selection results, i₁=i₀. When t=2*i₀+1, that is, the number t of detection modules 111 included in the first detection module group 11 is an odd positive integer greater than or equal to 3, for every two adjacent detection modules 111 among the first 2*i₀ detection modules 111 of the first detection module group 11, the flight time data set corresponding to each is input into one first-level data selection module 7211, generating i₀ first-level sub-selection results. The i₀ first-level sub-selection results and the flight time data set corresponding to the (2*i₀+1)^{th} detection module 111 (that is, the t^{th} detection module 111) of the first detection module group 11 together form i₁ first-level selection results, i₁=i₀+1.

When the number of j^{th}-level selection results iⱼ=2*iⱼ₀, iⱼ₀ is a positive integer greater than or equal to 1, the second group of first selection components 721 includes iⱼ₀ (j+1)^{th}-level data selection modules 721 (j+1). For every two adjacent j^{th}-level selection results among the 2*iⱼ₀ j^{th}-level selection results, each is input into one (j+1)^{th}-level data selection module 721 (j+1), generating iⱼ₊₁ (j+1)^{th}-level selection results, iⱼ₊₁=iⱼ₀. When the number of j^{th}-level selection results iⱼ₌₂*iⱼ₀+1, for the first iⱼ₌₂*iⱼ₀ j^{th}-level selection results among the 2*iⱼ₀+1 j^{th}-level selection results, every two adjacent j^{th}-level selection results are input into one (j+1)^{th}-level data selection module 721 (j+1), generating iⱼ₀ j^{th}-level sub-selection results. The iⱼ₀ j^{th}-level sub-selection results and the (2*iⱼ₀+1)^{th} j^{th}-level selection result together form iⱼ₊₁ (j+1)^{th}-level selection results, iⱼ₊₁=iⱼ₀+1. j is a positive integer, 1≤j≤k−1, and iⱼ₀ is a positive integer greater than or equal to 2. When j=k−1, the number of (k−1)^{th}-level selection results iₖ₋₁=2. The second group of first selection components 721 includes i₍ₖ₋₁₎₀ k^{th}-level data selection modules 721k, i₍ₖ₋₁₎₀=1, that is, the first group of first selection components 721 includes one k^{th}-level data selection module 721k. One k^{th}-level data selection module 721k is used to receive two (k−1)^{th}-level selection results and output one k^{th}-level selection result.

When the first-level data selection module 7211 to the k^{th}-level data selection module 721k in the second group of first selection components 721 all select the flight time data set corresponding to a certain detection module 111 in the second detection module group 12, the k^{th}-level data selection module 721k outputs the flight time data set corresponding to the detection module 111 to the second group of first statistics components 321. The second group of first statistics components 321 count the flight time data set corresponding to the detection module 111 to generate the histogram data corresponding to the detection module 111.

Specifically, when the first-level data selection module 7211 to the k^{th}-level data selection module 721k in the second group of first selection components 721 all select the flight time data set corresponding to the (2t)^{th} detection module 111 during the Tn period, the k^{th}-level data selection module 721k outputs the flight time data set corresponding to the (2t)^{th} detection module 111 to the second group of first statistics components 321. The second group of first statistics components 321 count the flight time data set corresponding to the (2t)^{th} detection module 111 to generate the histogram data corresponding to the first detection module 111. When the first-level data selection module 7211 to the k^{th}-level data selection module 721k in the second group of first selection components 721 all select the flight time data set corresponding to the (2t−1)^{th} detection module 111 during the T₁₂ period, the k^{th}-level data selection module 721k outputs the flight time data set corresponding to the (2t−1)^{th} detection module 111 to the second group of first statistics components 321. The second group of first statistics components 321 count the flight time data set corresponding to the (2t−1)^{th} detection module 111 to generate the histogram data corresponding to the (2t−1)^{th} detection module 111 . . . . When the first-level data selection module 7211 to the k^{th}-level data selection module 721k in the second group of first selection components 721 select the flight time data set corresponding to the (t+1)^{th} detection module 111 during the T₁ₜ period, the k^{th}-level data selection module 721k outputs the flight time data set corresponding to the (t+1)^{th} detection module 111 to the second group of first statistics components 321. The second group of first statistics components 321 count the flight time data set corresponding to the (t+1)^{th} detection module 111 to generate the histogram data corresponding to the (t+1)^{th} detection module 111.

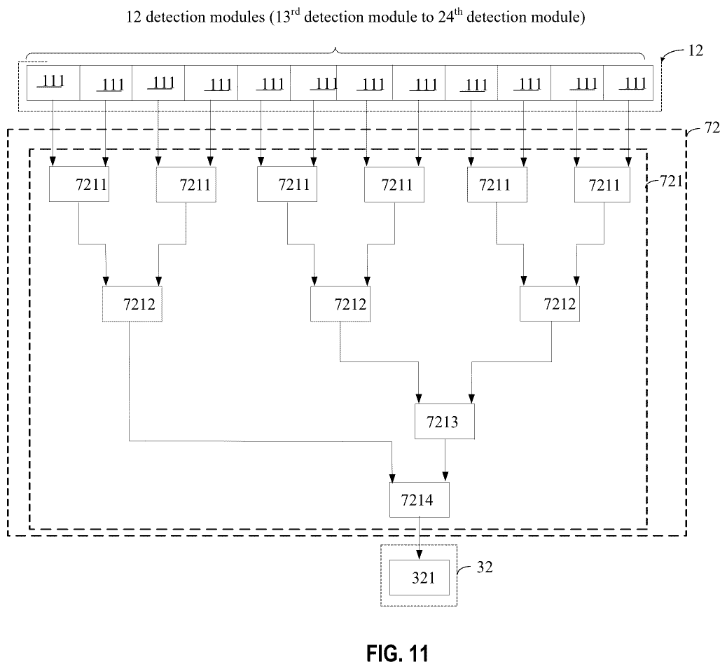

As shown in FIG. 11, in an embodiment, t=12, and the second detection module group 12 includes 12 detection modules 111 (that is, the twelfth detection module 111 to the twenty-third detection module 111). The second group of first selection components 721 includes a first-level data selection module 7211, a second-level data selection module 7212, a third-level data selection module 7213, and a fourth-level data selection module 7214. The number of first-level data selection modules 7211 included in the second group of first selection components 721 is i₀=6. For every two adjacent detection modules 111 among the 12 detection modules 111 included in the first detection module group 11, the flight time data set corresponding to each is input into one first-level data selection module 7211. The 12 detection modules 111 correspond to six first-level data selection modules 7211, generating six first-level selection results. Furthermore, the number of second-level data selection modules 7212 included in the second group of first selection components 721 is i₁₀₌₃. For every two adjacent first-level selection results among the six first-level selection results, each is input into one second-level data selection module 7212. The six first-level selection results correspond to three second-level data selection modules 7212, generating three second-level selection results. Furthermore, the number of third-level data selection modules 7213 included in the second group of first selection components 721 is i₂₀₌₂. Among the three second-level selection results, the first two second-level selection results are input into one third-level data selection module 7213, generating one third-level sub-selection result. The third-level sub-selection result and the third second-level selection result among the three second-level selection results together form two third-level selection results. Furthermore, the number of fourth-level data selection modules 7214 included in the second group of first selection components 721 is i₃₀₌₂. The two third-level selection results are input into one fourth-level data selection module 7214, generating one fourth-level selection result.

Specifically, when the first-level data selection module 7211 to the fourth-level data selection module 7214 in the second group of first selection components 721 all select the flight time data set corresponding to a certain detection module 111 among the 12 detection modules 111 in the second detection module group 12, the k^{th}-level data selection module 721k outputs the flight time data set corresponding to the detection module 111 to the second group of first statistics components 321. The second group of first statistics components 321 count the flight time data set corresponding to the detection module 111 to generate the histogram data corresponding to the detection module 111.

The second group of first selection components 721 provided in the above embodiment perform multi-level selection on the flight time data set corresponding to each of the t detection modules 111 included in the second detection module group 12 through k-level data selection modules (that is, the first-level data selection module 7211 to the k^{th}-level data selection module 721k), so as to realize the sequential selection of the flight time data set corresponding to each of the t detection modules 111 included in the second detection module group 12 according to the second preset order, and output, in a time-sharing manner, the flight time data set corresponding to each of the t detection modules 111 included in the second detection module group 12.

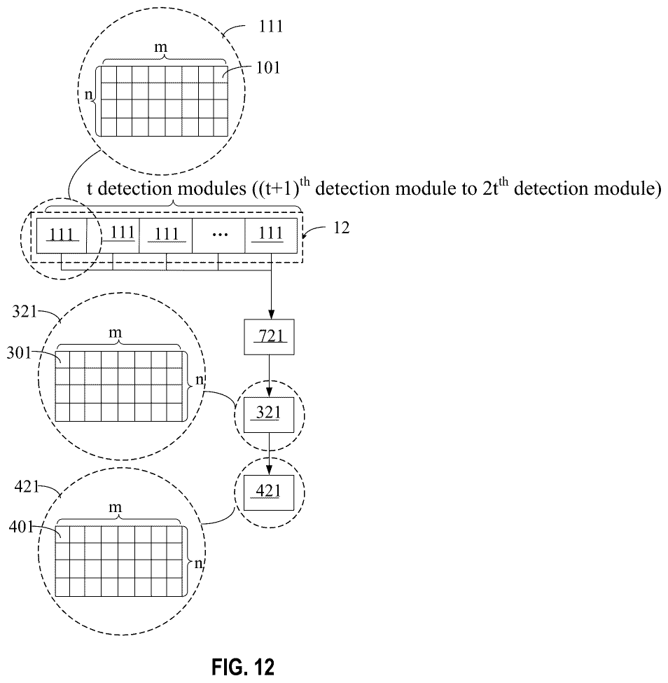

Furthermore, as shown in FIG. 12, the second group of first statistics components 321 includes m*n statistics units 301. The m*n statistics units 301 are respectively used to count the flight time data set corresponding to each of the m*n detection units 101 included in the detection module 111 selected by the second group of first selection components 721, and generate the histogram data corresponding to each of the m*n detection units 101. For example, assuming that any one of the m*n detection units 101 is the p*q^{th} detection unit 101, where p and q are both positive integers, and 1≤p≤m, 1≤q≤n, correspondingly, the p*q^{th} statistics unit 301 in the second group of first statistics components 321 is configured to count the flight time data set corresponding to the p*q^{th} detection unit 101 of the detection module selected by the second group of first selection components 721, and generate the histogram data corresponding to the p*q^{th} detection unit 101 of the detection module selected by the second group of first selection components 721.

Furthermore, as shown in FIG. 8, the storage module group 40 further includes a first storage module 41 and a second storage module 42. The first storage module 41 includes a first group of first storage components 411. The first group of first storage components 411 correspond one-to-one with the first group of first statistics components 311 and are used to write and output the histogram data obtained by the first group of first statistics components 311, so as to write and output, in a time-sharing manner and according to the first preset order, the histogram data corresponding to each of the t detection modules 111 included in the first detection module group 11. The second storage module 42 includes a second group of first storage components 421. The second group of first storage components 421 correspond one-to-one with the second group of first statistics components 321 and are used to write and output the histogram data obtained by the second group of first statistics components 321, so as to write and output, in a time-sharing manner and according to the second preset order, the histogram data corresponding to each of the t detection modules 111 included in the second detection module group 12.

As shown in FIG. 12, the first group of first storage components 411 includes m*n storage modules 401. The m*n storage modules 401 correspond one-to-one with the m*n detection units 101 included in each detection module 111 of the first detection module group 11 and are respectively used to write and output the histogram data corresponding to each of the m*n detection units 101. As shown in FIG. 12, the second group of first storage components 421 includes m*n storage units 4211. The m*n storage units 4211 correspond one-to-one with the m*n detection units 101 included in each detection module 111 of the second detection module group 12 and are respectively used to write and output the histogram data corresponding to each of the m*n detection units 101. For example, assuming that any one of the m*n detection units 101 is the p*q^{th} detection unit 101, where p and q are both positive integers, and 1≤p≤m, 1≤q≤n, correspondingly, the p*q^{th} storage module 401 is configured to write and output the histogram data corresponding to the p*q^{th} detection unit 101 among the t detection modules 111.

The time-of-flight measurement system provided by the present disclosure, through the first group of first storage components 411 corresponding one-to-one with the first group of first statistics components 311, writes and outputs, in a time-sharing manner and according to the first preset order, the histogram data corresponding to each of the t detection modules 111 included in the first detection module group 11. Only one first group of first storage components 411 is needed to write the histogram data corresponding to each of the t detection modules 111 included in the first detection module group 11. There is no need to set a one-to-one corresponding first group of first storage components 411 for each detection module 111, thereby saving the storage capacity required by the time-of-flight measurement system. By outputting, in a time-sharing manner, the histogram data corresponding to each of the t detection modules 111 included in the first detection module group 11 through the first group of first storage components 411, the subsequent hardware structure for data processing of the histogram data corresponding to the t detection modules 111 can be time-division multiplexed, thereby further saving the hardware resource overhead required for data processing by the time-of-flight measurement system. Similarly, the time-of-flight measurement system provided by the present disclosure, through the second group of first storage components 421 corresponding one-to-one with the second group of first statistics components 321, writes and outputs, in a time-sharing manner and according to the first preset order, the histogram data corresponding to each of the t detection modules 111 included in the second detection module group 12. Only one second group of first storage components 421 is needed to write the histogram data corresponding to each of the t detection modules 111 included in the second detection module group 12. There is no need to set up a one-to-one corresponding second group of first storage components 421 for each detection module 111, thereby saving the storage capacity required by the time-of-flight measurement system. By outputting, in a time-sharing manner, the histogram data corresponding to each of the t detection modules 111 included in the second detection module group 12 through the second group of first storage components 421, the subsequent hardware structure for data processing of the histogram data corresponding to the t detection modules 111 can be time-division multiplexed, thereby further saving the hardware resource overhead required for data processing by the time-of-flight measurement system.

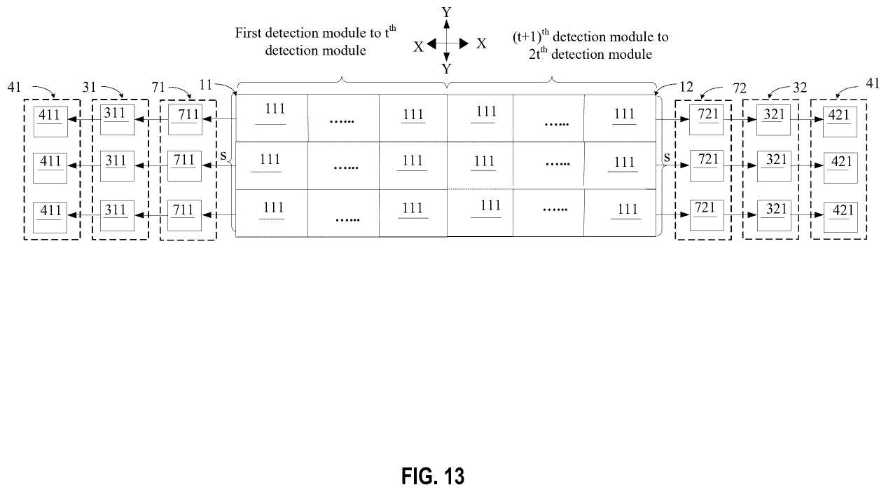

As shown in FIG. 13, in some embodiments, the detector array 10 includes s first detection module groups 11 and s second detection module groups 12, where s is a positive integer greater than 1. The s first detection module groups 11 are arranged along the second direction Y-Y, and the s second detection module groups 12 are arranged along the second direction Y-Y. The first selection module group 71 includes s first groups of first selection components 711, each corresponding to one of the s first detection module groups 11. The first statistics module 31 includes s first groups of first statistics components 311, each corresponding to one of the s first groups of first selection components 711. The first storage module 41 includes s first groups of first storage components 411, each corresponding to one of the s first groups of first statistics components 311. The second selection module 72 includes s second groups of first selection components 721, each corresponding to one of the s second detection module groups 11. The second statistics module 32 includes s second groups of first statistics components 321, each corresponding to one of the s second groups of first selection components 721. The second storage module 42 includes s second groups of first storage components 421, each corresponding to one of the s second groups of first statistics components 321. The embodiment of the present disclosure, by providing the first detection module group 11 and the second detection module group 12 along the first direction X-X, can expand the detection field of view of the detector array 10 along the first direction X-X. At the same time, by providing a plurality of first detection module groups 11 and a plurality of second detection module groups 12 along the second direction, the detection field of view of the detector array 10 along the second direction Y-Y can be expanded.

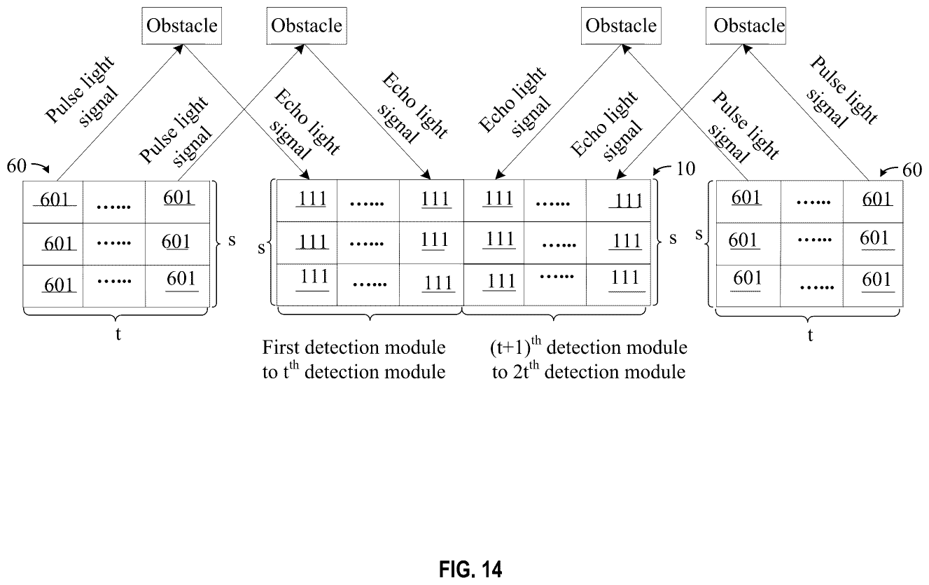

As shown in FIG. 14, the above time-of-flight measurement system further includes two laser arrays 60. The two laser arrays 60 are located on both sides of the detector array 10. Each laser array includes s*t light emitting units 601, and each light emitting unit 601 corresponds one-to-one with a detection module 111 in the detector array 10.

In some embodiments, the first selection module group 71 further includes a first group of second selection components (not shown) to a first group of U^{th} selection components (not shown), where U is a positive integer and 2≤U<t. The first statistics module 31 further includes a first group of second statistics components (not shown) to a first group of U^{th} statistics components (not shown). The first group of u^{th} selection components are used to select, in sequence, the flight time data set corresponding to each of the u^{th} detection module to the (t+u−1)^{th} detection module according to the first preset order, so as to output, in a time-sharing manner, the flight time data set corresponding to each of the u^{th} detection module to the (t+u−1)^{th} detection module to the first group of u^{th} statistics components. u is a positive integer and 2≤u≤U. The first group of u^{th} statistics components correspond to the first group of u^{th} selection components and are used to count the flight time data set corresponding to the detection module selected by the first group of u^{th} selection components, so as to generate the histogram data corresponding to the detection module selected by the first group of u^{th} selection components.

The second selection module 72 further includes a second group of second selection components (not shown) to a second group of U^{th} selection components (not shown). The second statistics module 32 further includes a second group of second statistics components (not shown) to a second group of U^{th} statistics components (not shown). The second group of u^{th} selection components are used to select, in sequence, the flight time data set corresponding to each of the (2t−u+1)^{th} detection module to the (t−u)^{th} detection module according to the second preset order, so as to output, in a time-sharing manner, the flight time data set corresponding to each of the (2t−u+1)^{th} detection module to the (t−u)^{th} detection module to the second group of u^{th} statistics components. The second group of u^{th} statistics components correspond to the second group of u^{th} selection components and are used to count the flight time data set corresponding to the detection module selected by the second group of u^{th} selection components, so as to generate the histogram data corresponding to the detection module selected by the second group of u^{th} selection components.

The time-of-flight measurement system provided in the embodiments of the present disclosure, through the first group of second selection components to the first group of U^{th} selection components, sequentially selects the U−1 detection modules to the right of the detection module 111 currently selected by the first group of first selection components 711, so as to simultaneously count the histogram data of the U−1 detection modules to the right of the detection module 111 currently selected by the first group of first selection components 711. This facilitates the use of the histogram data of adjacent detection modules 111 for fusion to obtain more accurate measurement results. Similarly, the time-of-flight measurement system provided in the embodiments of the present disclosure, through the second group of second selection components to the first group of U^{th} selection components, sequentially selects the U−1 detection modules to the left of the detection module 111 currently selected by the second group of first selection components 721, so as to simultaneously count the histogram data of the U−1 detection modules to the left of the detection module 111 currently selected by the second group of first selection components 721. This facilitates the use of the histogram data of adjacent detection modules 111 by the control and processing module 50 for fusion to obtain more accurate measurement results.

The working principle and structure of the first group of u^{th} selection components are similar to those of the first group of first selection components 711. The working principle and structure of the first group of u^{th} selection components can refer to the first group of first selection components 711, and will not be repeated here. The working principle and structure of the second group of u^{th} selection components are similar to those of the second group of first selection components 721. The working principle and structure of the second group of u^{th} selection components can refer to the second group of first selection components 721, and will not be repeated here. The working principle and structure of the first group of u^{th} statistics components are similar to those of the first group of first statistics components 311. The working principle and structure of the first group of u^{th} statistics components can refer to the first group of first statistics components 311, and will not be repeated here. The working principle and structure of the second group of u^{th} statistics components are similar to those of the second group of first statistics components 321. The working principle and structure of the second group of u^{th} statistics components can refer to the second group of first statistics components 321, and will not be repeated here.

The first storage module 41 further includes a first group of second storage components (not shown) to a first group of U^{th} storage components (not shown). The first group of second storage components 412 correspond to the first group of second statistics components 312 and are used to write and output the histogram data obtained by the first group of second statistics components 312, so as to realize the time-sharing writing and output of the histogram data corresponding to the second detection module to the (t+1)^{th} detection module 111. The first group of u^{th} storage components correspond to the first group of u^{th} statistics components and are used to write and output the histogram data obtained by the first group of u^{th} statistics components, so as to realize the time-sharing writing and output of the histogram data corresponding to the u^{th} detection module to the (t+u−1)^{th} detection module. The second storage module 42 further includes a second group of second storage components (not shown) to a second group of U^{th} storage components (not shown). The second group of second storage components 422 correspond to the second group of second statistics components 322 and are used to write and output the histogram data obtained by the second group of second statistics components 322, so as to realize the time-sharing writing and output of the histogram data corresponding to the (2t−1)^{th} detection module to the (t−1)^{th} detection module 111. The second group of u^{th} storage components correspond to the second group of u^{th} statistics components and are used to write and output the histogram data obtained by the second group of u^{th} statistics components, so as to realize the time-sharing writing and output of the histogram data corresponding to the (2t−u+1)th detection module to the (t−u)^{th} detection module.

In an embodiment, U=3.

In an embodiment, the control and processing module 50 is further used to perform fusion processing on the histogram data stored in the first group of first storage components 411 to the first group of U^{th} storage components, so as to obtain more accurate time-of-flight measurement results. The control and processing module 50 is further used to perform fusion processing on the histogram data stored in the second group of first storage components 421 to the second group of U^{th} storage components, so as to obtain more accurate time-of-flight measurement results.

When U=3, the control and processing module 50 is used to perform fusion processing on the histogram data stored in the first group of first storage components 411, the first group of second storage components, and the first group of third storage components, so as to obtain more accurate time-of-flight measurement results. The control and processing module 50 is used to perform fusion processing on the histogram data stored in the second group of first storage components 421, the second group of second storage components, and the second group of third storage components, so as to obtain more accurate time-of-flight measurement results.

In another embodiment, the control and processing module 50 performs fusion processing on the histogram data of the same detection module 111 in the first detection module group 11 during multiple scanning processes, so as to obtain more accurate time-of-flight measurement results.

In an embodiment, the light emitting unit 601 may adopt a vertical-cavity surface-emitting laser (VCSEL), edge emitting laser (EEL), light emitting diode (LED), micro light emitting diode (Micro LED), pulsed laser deposition (PLD), or laser diode (LD), etc. The present disclosure does not limit the type of the light emitting unit 601.

The present disclosure further provides a laser ranging device, including the above time-of-flight measurement system. The laser ranging device generates a point cloud map based on the time-of-flight of the obstacle determined by the time-of-flight measurement system, and obtains parameters such as the distance, orientation, height, speed, attitude, and shape of the obstacle by processing the point cloud map, thereby realizing the laser detection function, and can be applied to navigation and obstacle avoidance, obstacle recognition, ranging, speed measurement, autonomous driving, and other scenarios of products such as automobiles, robots, logistics vehicles, inspection vehicles, etc.

It should be understood that the order of the operations in the above embodiments does not imply the order of execution, and the execution order of each process should be determined according to its function and internal logic, and should not constitute any limitation on the implementation process of the embodiments of the present disclosure.

The above are only embodiments of the present disclosure and are not intended to limit the present disclosure. For those skilled in the art, the present disclosure may have various modifications and changes. Any modifications, equivalent substitutions, improvements, etc., made within the spirit and principle of the present disclosure should be included within the scope of the claims of the present disclosure.

What is claimed is:

1. A time-of-flight measurement system, comprising:
a detector array, comprising a first detection module group, wherein the first detection module group comprises t detection modules arranged in sequence, and each detection module comprises m*n detection units, wherein t, m, and n are all positive integers, and t≥1, m≥1, and n≥1; and
a statistics module, comprising a first selection module group and a first statistics module group, wherein the first selection module group comprises a first group of first selection components, the first group of first selection components corresponds to the first detection module group one by one, the first statistics module group comprises a first group of first statistics components, and the first group of first statistics components corresponds to the first group of first selection components one by one,
wherein the first group of first selection components are configured to select, in sequence, a flight time data set corresponding to each of the t detection modules comprised in the first detection module group according to a first preset order, so as to output, in a time-sharing manner, the flight time data set corresponding to each of the t detection modules comprised in the first detection module group to the first group of first statistics components, each flight time data set is configured to indicate a photon event of one detection unit in one flight time statistics period, and the first group of first statistics components are configured to calculate a flight time data set corresponding to the detection module selected by the first group of first selection components, so as to generate histogram data corresponding to the detection module selected by the first group of first selection components.

2. The time-of-flight measurement system according to claim 1, wherein:
the t detection modules in the first detection module group comprise a first detection module to a t^{th} detection module arranged in sequence along a first direction, and the first preset order is from the first detection module to the t^{th} detection module, or the first preset order is from the t^{th} detection module to the first detection module.

3. The time-of-flight measurement system according to claim 2, wherein the first group of first selection components comprises a first-level data selection module to a k^{th}-level data selection module, and the first-level data selection module to the k^{th}-level data selection module are all 2-to-1 data selection modules, wherein k is a positive integer greater than 1, and 2^{k-1}≤t≤2^{k};
wherein, when t=2*i₀, i₀ is a positive integer greater than or equal to 1, the first group of first selection components comprises i₀ first-level data selection modules, and for the t detection modules comprised in the first detection module, a flight time data set corresponding to each of every two adjacent detection modules is input into one first-level data selection module, to generate i₁ first-level selection results, i₁=i₀; and when t=2*i₀+1, a flight time data set corresponding to each of every two adjacent detection modules in the first 2*i₀ detection modules of the first detection module is input into one first-level data selection module, to generate i₀ first-level sub-selection results, and the i₀ first-level sub-selection results and the flight time data set corresponding to the 2*i₀+1th detection module jointly form i₁ first-level selection results, i₁=i₀+1; and
wherein when the number of j^{th}-level selection results iⱼ=2*iⱼ₀, iⱼ₀ being a positive integer greater than or equal to 1, the first group of first selection components comprises iⱼ₀ (j+1)^{th}-level data selection modules, and each of every two adjacent j^{th}-level selection results in the 2*iⱼ₀ j^{th}-level selection results is input into one (j+1)^{th}-level data selection module, to generate iⱼ₊₁ (j+1)^{th}-level selection results, iⱼ₊₁=iⱼ₀; when the number of j^{th}-level selection results iⱼ₌₂*iⱼ₀+1, for the first iⱼ₌₂*iⱼ₀ j^{th}-level selection results of the 2*iⱼ₀+1 j^{th}-level selection results, each of every two adjacent j^{th}-level selection results is input into one (j+1)^{th}-level data selection module, to generate iⱼ₀ j^{th}-level sub-selection results, and the iⱼ₀ j^{th}-level sub-selection results and the (2*iⱼ₀+1)^{th} j^{th}-level selection result jointly form iⱼ₊₁ (j+1)^{th}-level selection results, iⱼ₊₁=iⱼ₀+1; and wherein j is a positive integer, 1≤j≤k−1, and iⱼ₀ is a positive integer greater than or equal to 2, and when j=k−1, the number of k−1th-level selection results iₖ₋₁=2.

4. The time-of-flight measurement system according to claim 1, wherein the first group of first statistics components comprises m*n statistics units, and the m*n statistics units are configured to calculate flight time data sets corresponding to the m*n detection units in the detection module selected by the first group of first selection components, so as to generate histogram data respectively corresponding to the m*n detection units.

5. The time-of-flight measurement system according to claim 1, further comprising:
a storage module group, comprising a first storage module, wherein the first storage module comprises a first group of first storage components, and the first group of first storage components correspond to the first group of first statistics components, and are configured to write and output histogram data obtained by the first group of first statistics components.

6. The time-of-flight measurement system according to claim 5, wherein the detector array comprises s first detection module groups, s is a positive integer, and s>1;
wherein the s first detection module groups are arranged along a second direction;
wherein the first selection module group comprises s first groups of first selection components respectively corresponding to the s first detection module groups;
wherein the first statistics module group comprises s first groups of first statistics components respectively corresponding to the s first groups of first selection components; and
wherein the first storage module comprises s first groups of first storage components respectively corresponding to the s first groups of first statistics components.

7. The time-of-flight measurement system according to claim 1, wherein the detector array further comprises a second detection module group, the second detection module group and the first detection module group are both arranged along the first direction, the second detection module group comprises t detection modules, and the time-of-flight measurement system further comprises:
a second selection module, comprising a second group of first selection components, wherein the second group of first selection components correspond to the second detection module group, and are configured to select, in sequence, flight time data sets corresponding to the t detection modules comprised in the second detection module group according to a second preset order, so as to output, in a time-sharing manner, the flight time data sets corresponding to the t detection modules comprised in the second detection module group to a second group of first statistics components,
wherein the statistics module further comprises a second statistics module, wherein the second statistics module comprises a second group of first statistics components, the second group of first statistics components correspond to the second group of first selection components, and are configured to calculate a flight time data set corresponding to the detection module selected by the second group of first selection components, so as to generate histogram data corresponding to the detection module selected by the second group of first selection components.

8. The time-of-flight measurement system according to claim 7, wherein the t detection modules comprised in the second detection module group comprise a first detection module to a t^{th} detection module arranged in sequence along the first direction; the t detection modules comprised in the second detection module group comprise a (t+1)^{th} to a 2t^{th} detection module arranged in sequence along the first direction; the first preset order is from the first detection module to the t^{th} detection module; and the second preset order is from the 2t^{th} detection module to the (t+1)^{th} detection module.

9. The time-of-flight measurement system according to claim 8, further comprising a storage module group, wherein the storage module group comprises:
a first storage module, comprising a first group of first storage components, wherein the first group of first storage components correspond to the first group of first statistics components, and are configured to write and output histogram data obtained by the first group of first statistics components; and
a second storage module, comprising a second group of first storage components, wherein the second group of first storage components correspond to the second group of first statistics components, and are configured to write and output histogram data obtained by the second group of first statistics components.

10. The time-of-flight measurement system according to claim 9, wherein the detector array comprises s first detection module groups and s second detection module groups, s is a positive integer greater than 1, the s first detection module groups are arranged along a second direction, and the s second detection module groups are arranged along the second direction; and
wherein the first selection module group comprises s first groups of first selection components respectively corresponding to the s first detection module groups, the first statistics module group comprises s first groups of first statistics components respectively corresponding to the s first groups of first selection components, the second selection module group comprises s second groups of second selection components respectively corresponding to the s second detection module groups, and the second statistics module comprises s second groups of first statistics components respectively corresponding to the s second groups of first selection components.

11. The time-of-flight measurement system according to claim 9, wherein the first selection module group further comprises a first group of second selection components to a first group of U^{th} selection components, U is a positive integer, and 2≤U≤t; the first statistics module group further comprises a first group of second statistics components to a first group of U^{th} statistics components, and the first group of u^{th} selection components are configured to select, in sequence, flight time data sets corresponding to the u^{th} detection module to the (t+u−1)^{th} detection module according to the first preset order, so as to output, in a time-sharing manner, the flight time data sets corresponding to the u^{th} detection module to the (t+u−1)^{th} detection module to the first group of u^{th} statistics components, wherein u is a positive integer, and 2≤u≤U; and the first group of u^{th} statistics components correspond to the first group of u^{th} selection components, and are configured to calculate a flight time data set corresponding to the detection module selected by the first group of u^{th} selection components, so as to generate histogram data corresponding to the detection module selected by the first group of u^{th} selection components;
wherein the second selection module group further comprises a second group of second selection components to a second group of U^{th} selection components; the second statistics module further comprises a second group of second statistics components to a second group of U^{th} statistics components; the second group of u^{th} selection components are configured to select, in sequence, flight time data sets corresponding to the (2t−u+1)^{th} detection module to the (t−u)^{th} detection module according to the second preset order, so as to output, in a time-sharing manner, the flight time data sets corresponding to the (2t−u+1)^{th} detection module to the (t−u)^{th} detection module to the second group of u^{th} statistics components; and the second group of u^{th} statistics components correspond to the second group of u^{th} selection components, and are configured to calculate a flight time data set corresponding to the detection module selected by the second group of u^{th} selection components, so as to generate histogram data corresponding to the detection module selected by the second group of u^{th} selection components; and
wherein the first storage module comprises a first group of second storage components to a first group of U^{th} storage components; the first group of u^{th} storage components correspond to the first group of u^{th} statistics components, and are configured to write and output histogram data obtained by the first group of u^{th} statistics components; the second storage module further comprises a second group of second storage components to a second group of U^{th} storage components; and the second group of u^{th} storage components correspond to the second group of u^{th} statistics components, and are configured to write and output histogram data obtained by the second group of u^{th} statistics components.

12. The time-of-flight measurement system according to claim 11, further comprising a control and processing module, wherein the control and processing module is configured to perform fusion processing on histogram data stored in the first group of first storage components, the first group of second storage components, and a first group of third storage components, and is also configured to perform fusion processing on histogram data stored in the second group of first storage components, the second group of second storage components, and a second group of third storage components.

13. A laser ranging device, comprising the time-of-flight measurement system, and a laser array,
wherein the time-of-flight measurement system comprises:
a detector array, comprising a first detection module group, wherein the first detection module group comprises t detection modules arranged in sequence, and each detection module comprises m*n detection units, wherein t, m, and n are all positive integers, and t≥1, m≥1, and n≥1; and
a statistics module, comprising a first selection module group and a first statistics module group, wherein the first selection module group comprises a first group of first selection components, the first group of first selection components corresponds to the first detection module group one by one, the first statistics module group comprises a first group of first statistics components, and the first group of first statistics components corresponds to the first group of first selection components one by one,
wherein the first group of first selection components are configured to select, in sequence, a flight time data set corresponding to each of the t detection modules comprised in the first detection module group according to a first preset order, so as to output, in a time-sharing manner, the flight time data set corresponding to each of the t detection modules comprised in the first detection module group to the first group of first statistics components, each flight time data set is configured to indicate a photon event of one detection unit in one flight time statistics period, and the first group of first statistics components are configured to: calculate a flight time data set corresponding to the detection module selected by the first group of first selection components, so as to generate histogram data corresponding to the detection module selected by the first group of first selection components
wherein the laser array comprises a light emitting unit that corresponds to one of the t detection modules.
